(19) United States
(12) Patent Application Publication
(10) Pub. No.: US 2013/0014433 A1
(43) Pub. Date: Jan. 17, 2013

(54) SUPPORT FRAME FOR HORTICULTURAL GROWING BAG AND PLANTS GROWN THEREFROM

(71) Applicants: Norman Pratt, Leicestershire (GB); Leon Cross, Peterborough (GB)

(72) Inventors: Norman Pratt, Leicestershire (GB); Leon Cross, Peterborough (GB)

(21) Appl. No.: 13/520,504

(22) PCT Filed: Dec. 3, 2010
(86) PCT No.: PCT/GB10/02230

§ 371 Date: Oct. 1, 2012

(30) Foreign Application Priority Data
Dec. 3, 2009 (GB) 0921226.5

(51) Int. Cl. A01G 9/12; A47G 7/00; A01G 13/02

(52) U.S. Cl. 47/30; 47/39; 211/85.15

(57) ABSTRACT

A free-standing support frame (1) for a horticultural growing bag (B) and plants (P) growing therefrom, the support frame comprising a pair of substantially A-shaped uprights (3), held in spaced apart relationship by upper and lower cross-members (5), the lower cross-member being adapted to engage with and support a horticultural growing bag (B) along one of its longitudinal edges. The growing bag is supported such that the bag presents an increase depth of growing media (C) for the roots (R) of the plant (P) to grow therein and form a void (V) over the growth media to retain a volume of water to percolate therethrough.

### CROSS-REFERENCE TO RELATED APPLICATIONS

This application claims priority from PCT/GB2010/002230, filed on Dec. 3, 2010, and published as WO 2011/067575 (published on Jun. 9, 2011) and which claims priority from GB 0921226.5 filed on Dec. 3, 2009, the contents of each of which are incorporated herein in their entirety by reference.

### FIELD OF THE INVENTION

The present invention relates to a frame for supporting a horticultural growing bag and plants growing therefrom. More particularly, the present invention relates to the provision of a free-standing support frame of the type adapted to train growing plants planted in a growing bag.

### BACKGROUND OF THE INVENTION

Over the last number of decades, the use of horticultural growing bags has increased markedly as a relatively easy way to provide plants with a nutrient rich growth medium.

References to growth media, soil, compost or mixes thereof should be understood by the skilled addressee as being non-limiting and interchangeable.

One of the known and well-appreciated disadvantages of existing growing bags is that of their shape, which is a substantially flat rectangular profile. This profile is very useful for handling, stacking and storing the growing bags but in use are laid flat and a longitudinal cut or rectangular hole is formed in the upper face to allow plants to grow therefrom.

UK Patent Application Publication No. 2 236 669 to BEVAN discloses a growing bag support frame for a plurality of growing bags slung from or between support bars. The support bars rest in upwardly facing notches provided either at the apex of each of two A-frames, which from upright end stands, or formed in horizontal bearers which, together with a horizontal base, secure the legs of the A-frame. The teaching of the document is directed towards maximising capacity (to elevate growing bags from limited available floor or ground space) and does not disclose means for supporting growing plants. It would appear that the upper level would impede development of plants grown from a lower level and repositioning of a frame with growing bags and plants growing therefrom would be problematic due to weight alone.

United Kingdom Patent Application Publication Nos 2 237 964 to EASILOK LTD and 2 219 479 to NABEY are typical of existing support frames which address the disadvantages familiar to all gardeners by obviating the need for plant support stakes which in traditional arrangements are pushed through the plastics material of the growing bag and into the ground below. It will be apparent that stakes cannot be pushed through a growing bag and provide adequate support where the grow bag is positioned on a solid base, such as that found in a patio, conservatory and in many greenhouses. The other known disadvantage of using stakes penetrating the bottom of a growing bag is that the nutrients provided within the growth medium can be lost by leaching through the stake holes.

In each of the above referred disclosures, the growing bag is placed on base elements of the support frame to provide ballast and maintain two end sections in an upright orientation between which two or more cross-members are provided.

Another of the appreciated disadvantages of growing bags is that once opened they are difficult to transport without spilling the contents or damaging the roots or the stalks of plants already growing from the bag. In addition to the solution provided in the above-referenced disclosures, UK Patent Application Publication Nos 2 336 091 to COBB and 2 268 040 to MELVILLE provide plant support frames comprising a base container or tray, in which a growing bag is placed, and frame elements upstanding from said container or tray to hold cross-members.

These cross-members in turn are used to provide support for plants growing from the growing bags.

The traditional arrangements of growing bags, where stakes or canes are free standing in the compost, and the support frame arrangements exemplified in the prior art do not however appear to appreciate the disadvantages associated with positioning the growing bags with one major flat surface resting on the ground or within a tray and opening the opposite, upper major flat surface for planting the required plants and watering. It has been noted that the growth medium, whether soil, compost or mixtures comprising either or both, has a tendency to compact. This, in addition to the reduced depth of medium available has a deleterious effect on the growing conditions for the plants. This arises primarily due to the conditions encountered by the plant roots, the support provided to the plants by their respective root structures and the nutrients gathered by under-developed roots. It has been further noted that when watering, there is a tendency for water to run off compacted growth media, lessening the amount of water absorbed, often flooding the area immediately surrounding the growing bag. Thus, the lack of a constraining wall or boundary defined by the plastics material of the growing bag means that the plants often do not receive an adequate supply of water. It will be appreciated however that to form a water void, that is a volume to allow water to collect before soaking into the growth media, the depth of media would have to be reduced further, accentuating the disadvantages referred to above.

It is an object of the present invention to seek to alleviate the above disadvantages and to provide an improved support frame for a horticultural growing bag and plants grown therefrom.

It is a further object of the present invention to provide a growing bag support frame which provides an enhanced depth of available growth media to ensure optimum conditions for root structures to form and a water void to ensure plants receive an adequate supply of water.

### SUMMARY OF THE INVENTION

A free-standing support frame for a horticultural growing bag and plants growing therefrom, the support frame comprising a pair of substantially A-shaped uprights, held in spaced apart relationship by upper and lower cross-members, the lower cross-member being adapted to engage with and support a horticultural growing bag along one of its longitudinal edges.

Advantageously, a growing bag is supported such that the bag presents an increase depth of growing media for the roots of the plant to grow therein.

Conveniently, a void is formed over the growth media to retain a volume of water to percolate therethrough.

Preferably, plant support means is held between the upper and lower cross-members.

Ideally, the plant support means comprises a plurality of straps tensioned between said cross-members.

Optionally or additionally, the plant support means comprises a mesh.

Advantageously, each A-shaped upright has an upper and a lower apex adapted to engage with one end of a cross-member.

Preferably each cross-member is provided with a receiver at each end thereof so sized and shaped as to securely fasten to the apex of an upright.

Ideally, the cross-member receiver comprises a crook having a biasing force to be overcome when receiving and engaging with an apex of an upright.

Advantageously, the crook is manually push-fitted onto the apex of an upright.

Preferably, the uprights and cross-members are made of metal.

Conveniently, the uprights and cross-members are formed using solid steel wire.

Advantageously, the uprights, cross-members and straps are flat-packed for packaging, distribution, storage and sale.

The frame may also include a material skirt adapted to fit over the frame and obscure the growing bag from view.

A cover may also be provided for the frame to protect plants from frost and/or insect infestations.

Advantageously, the cover includes access means to water and tend to the plants growing in the bag.

The support frame is securable to a second frame to ensure stability by the provision of a side bar connectable between the cross-members.

Optionally, the side bar includes an apex along its length to which a supplemental cross-member may be secured.

In one arrangement, a growing bag may be supported between two existing and growing bag supporting frames.

In an alternative arrangement, a side bar is fixed to a cross-member and is adapted to support additional cross-members so that a single frame may support up to three growing bags along their respective longitudinal edges.

### BRIEF DESCRIPTION OF THE DRAWINGS

The present invention will now be described more particularly with reference to the accompanying drawings which show, by way of example only, one embodiment of the support frame for a horticultural bag and the plants grown therefrom in accordance with the invention. In the drawings:

FIG. 1a is a sectioned elevation of a growing bag in a traditional flattened position illustrating the lack of depth of growth medium available for the root structure of a plant growing therein;

FIG. 1b is a sectional side elevation of a growing bag supported along one longitudinal edge by a support frame of the invention;

FIG. 2 is an elevation of the components utilised to form the support frame;

FIGS. 3a to 3c are detailed views of the uprights to which the cross-members are coupled;

FIGS. 4a to 4c are detailed views of the cross-members and the coupling of the cross-members to the uprights;

FIGS. 5a and 5b are side and end elevations of plant support straps engaged by and held between the upper and lower cross-members;

FIG. 6 is a perspective elevation of an assembled support frame including a supported growing bag;

FIG. 7 is a sectional end elevation of the support frame illustrating the available depth of media and water collecting within the void formed between the top of the media and the openings formed within the growing bag;

FIGS. 8a and 8b are perspective views of a material skirt adapted to obscure the growing bag from view when positioned over the frame;

FIG. 9 is a perspective view of a support frame to which a material net has been fixed to the upper and lower cross-members to provide a platform through which creeping plants may entwine;

FIG. 10 is a perspective view of a support frame over which a protective cover is placed;

FIGS. 11a to 11c are views of a first arrangement of side bars for coupling a first support frame to a second frame; and

FIGS. 12a and 12b are views of a second arrangement of side bars for attaching to the upper and lower cross-members of a support frame to facilitate carrying further cross-members.

### DETAILED DESCRIPTION OF THE DRAWINGS

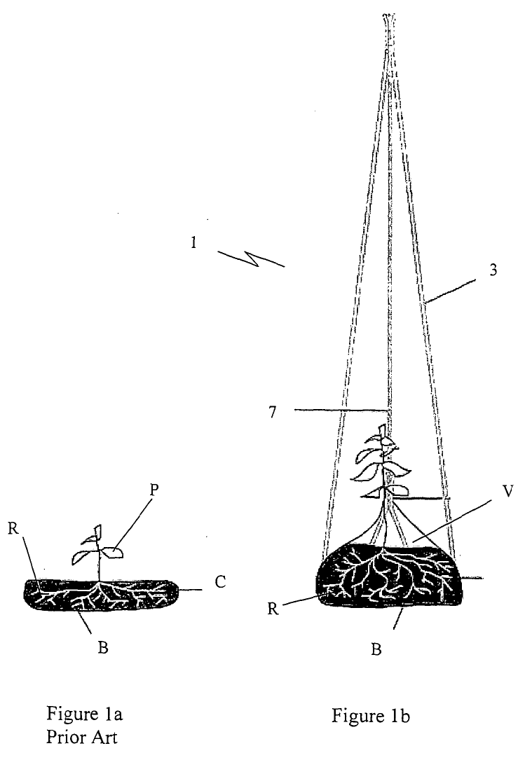

Referring to the drawings and initially to FIGS. 1a and 1b, one of the perceived major disadvantages of existing growing bags B is that there is insufficient depth of material C available to allow a supportive root structure R to flourish. This is again hampered by poor penetration or retention of water within the bag due to compaction of the growth medium C used, normally compost, soil or a mixture of both, together with added nutrients. It is undoubtedly more convenient to use the growing bag B as a container in preference to filling individual pots or transferring the growth medium to another tray or similarly shaped container. By elevating the growing bag along one of its longitudinal edges, the growth medium is re-orientated in the bag and assumes a more squat profile thereby providing a greater depth of media for the roots R to penetrate. As shown in FIG. 1b, the bag is supported by the frame 1 at a height selected so that the bag remains in major contact with the ground and at the upper supported side of the bag, a void V is formed to retain water poured into the bag which may then slowly percolate through the compost C.

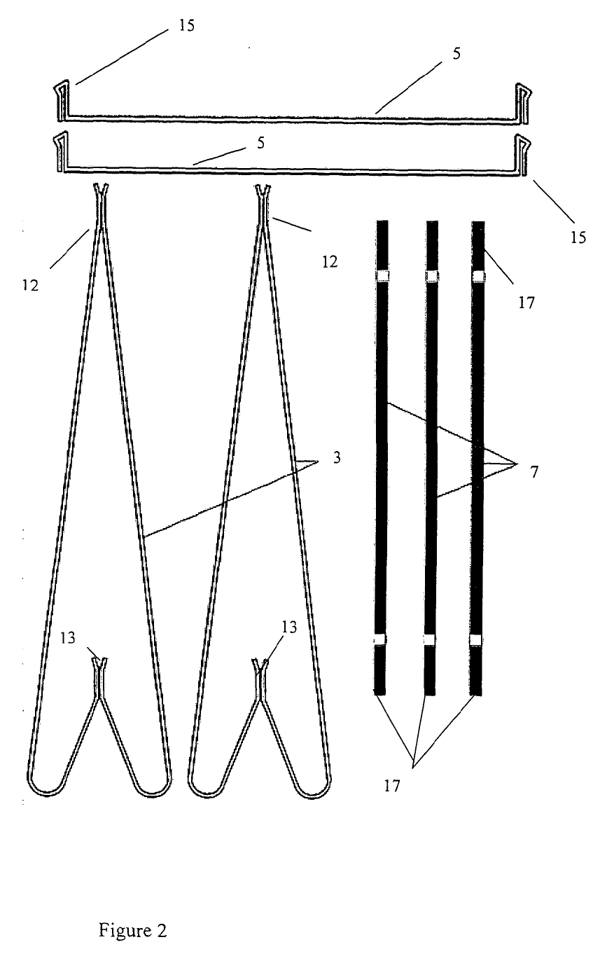

The frame 1 comprises a pair of substantially A-shaped uprights 3, cross-members 5 and plant support straps 7. In the preferred construction, only seven constituent parts are required, as illustrated in FIG. 2, however, it will be appreciated that the support frame may be formed using only three differently shaped elements, providing for easy of manufacture and self-assembly. Although only three straps 7 are illustrated, no such restriction should be implied or taken.

Each upright 3 is formed from two identical pieces of solid steel wire having a diameter in the range of approximately 4 mm to 8 mm, with 6 mm diameter being preferred. Ideally, the steel is recycled steel however it will be appreciated that other materials having sufficient strength can be used.

Plastics coating, galvanising and other known protective techniques can be used to enhance longevity of the frame.

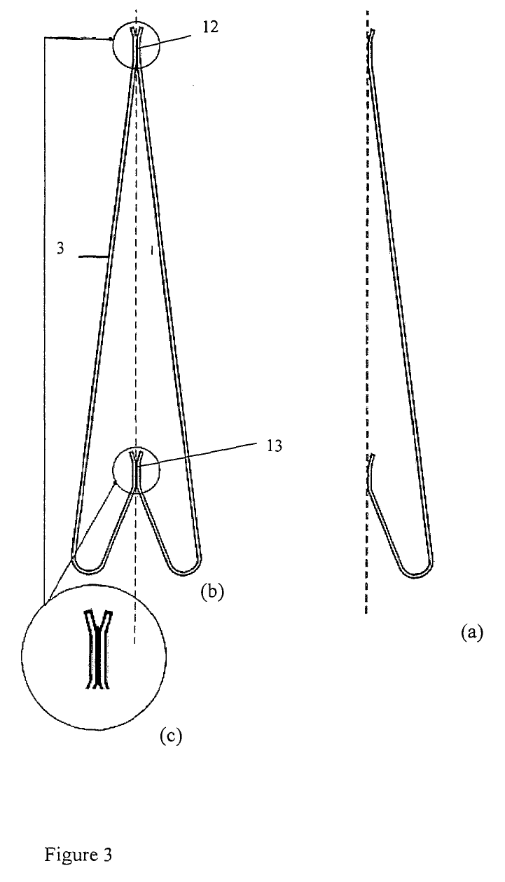

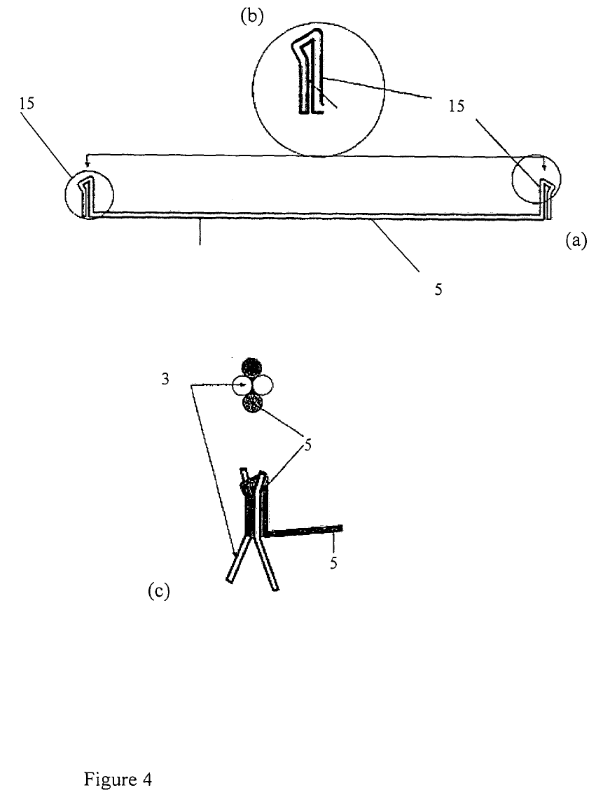

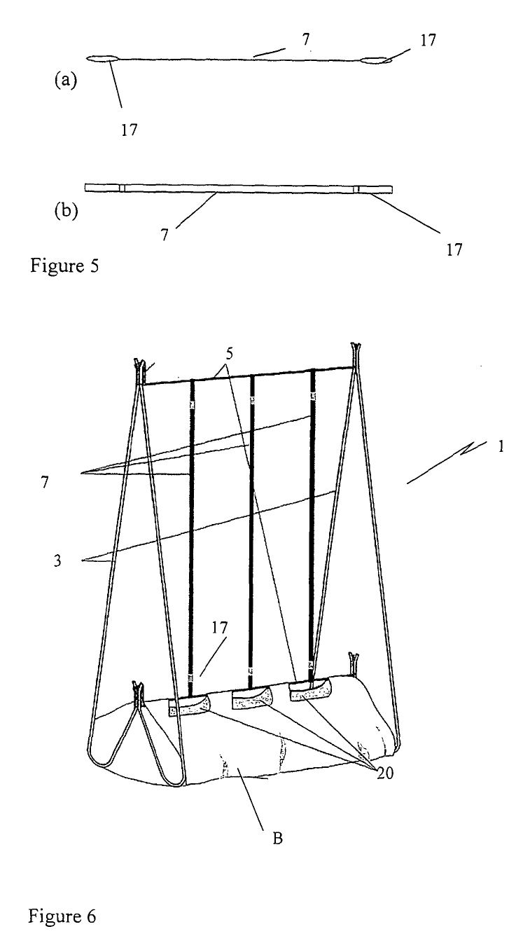

With reference to FIGS. 3a to 3c, the steel wire elements making up the uprights are formed and bonded together (ideally by spot welding) to form upper and lower apices 12,13 with a flared mouth to engage the cross-members 5. As shown in FIGS. 4a to 4c, the cross-members 5 have a receiving crook 15 at each end of their lengths, the crooks being so sized and shaped as to slidingly receive the apices 12,13 of the uprights 3 which are held in spaced apart relationship by the cross-members to complete the frame. Once assembled, the frame provides good stability which is further enhanced by the straps and the weight of a growing bag on the lower cross-member. As the frame is being assembled, the straps 7, as shown in FIGS. 5a and 5b, which have loops 17 which slide over the crooks 15, are threaded onto the cross-members 5 providing support for the climbing plants and a convenient and stable structure to which growing plants may be tied. It will be appreciated that where plants are grown taller than the upper cross-member, canes may be tied to the cross-members.

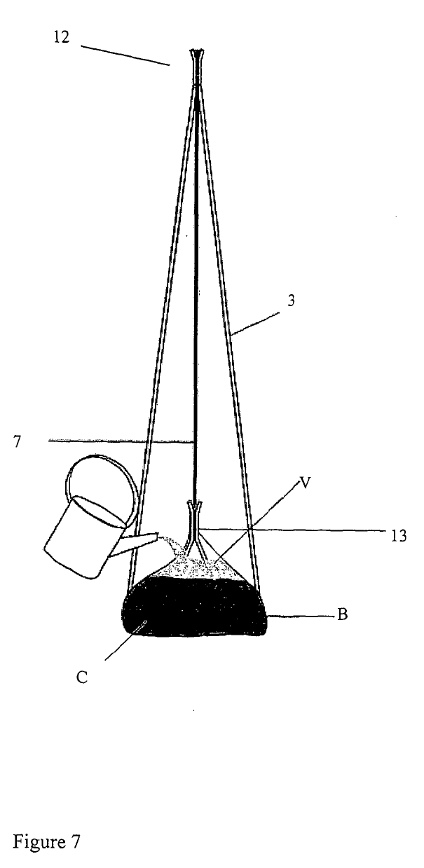

Referring now to FIGS. 6 and 7, in use the frame is partially assembled by fixing upper cross-member to the uprights and positioning a growing bag along its narrow longitudinal edge between the uprights. The growing bag is then prepared for support with the frame by forming cross-member receiving holes at each end of the selected longitudinal edge of the bag.

A number of plant apertures 20 are then cut along the edge, the apertures being of sufficient dimension to allow plants to grow therethrough whilst retaining sufficient bag material to ensure a water void is formed. The lower cross-member is then threaded progressively through the bag and the strap loops 17, which are aligned with the plant apertures 20. When the cross-member is completely through the bag, the cross-member crooks 15 are pushed down onto the lower apices 13. The upper cross-member 5 is then removed from its secured position on the upper apices 12 to allow the free loops 17 to be attached threadingly to that cross-member. Once the straps are in position, the cross-member is fixed back into position.

Plants can be placed within the growth media C through the apertures. With less compacted compost, planting is easier. When watering, a volume of water will be retained within the void V and allowed soak into the compost without overflowing the edges of the apertures 20.

To move the assembled frame and growing bag, the uprights should be gripped and the support frame gently repositioned. Care should be taken not to lift the assembled frame by the upper cross-member.

As well as being easy to assemble, the frame may be disassembled and reassembled at will and conveniently stored in a flattened configuration when not in use.

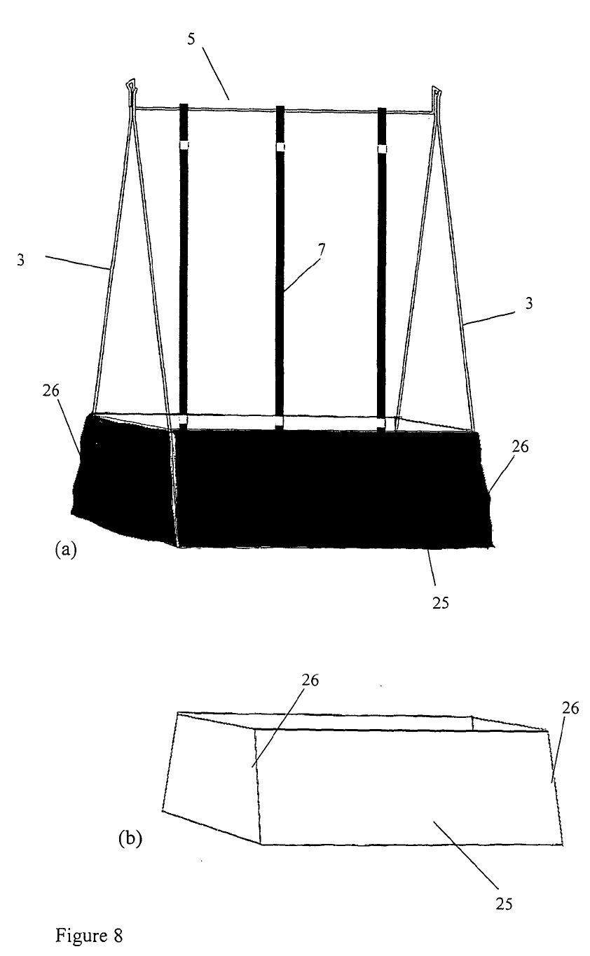

FIGS. 8a and 8b illustrate a skirt 25 adapted to fit over the frame is formed from any convenient material, including fabrics or plastics. The skirt ideally is opaque and may be decorated so as to obscure the growing bag B from view. The skirt includes seams 26 formed along its corners to provide a tapered shape to conform with the profile of the frame.

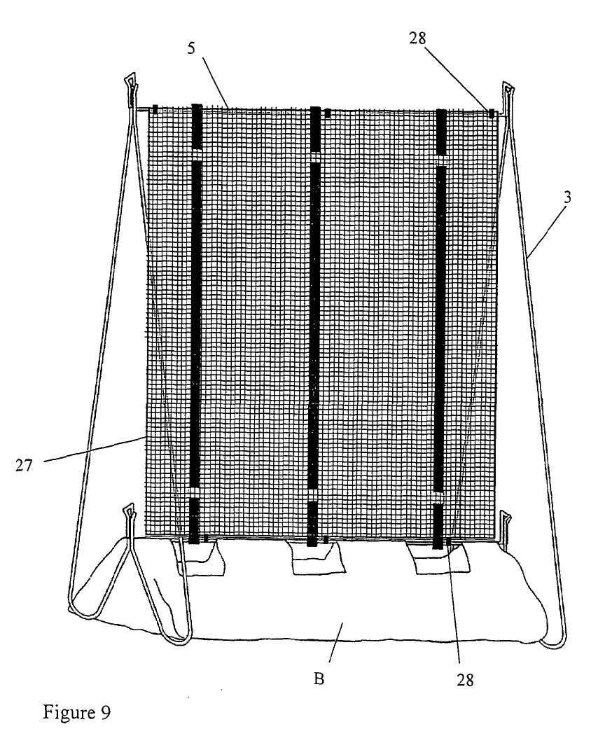

Plant support may be augmented by securing a mesh or net 27 to the cross-members 5 using a series of clips 28, as shown in FIG. 9. The net may comprise polypropylene or like material and is advantageously used with creeping plants.

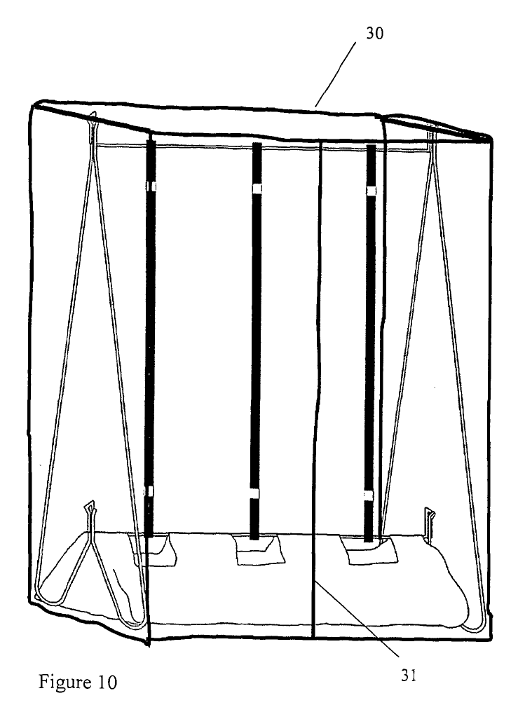

In FIG. 10, a plastics material cover 30 having a slit 31 along the front surface on one side to provide easy access to the plants, is positioned over the frame to protect young or susceptible plants from frost and may also be used to attenuate insect infestations. The cover 30 may be clear or opaque depending on the desired use and includes a slot through which the upper apices of the frame may protrude. The cover rests on the ground and may be secured at the apices.

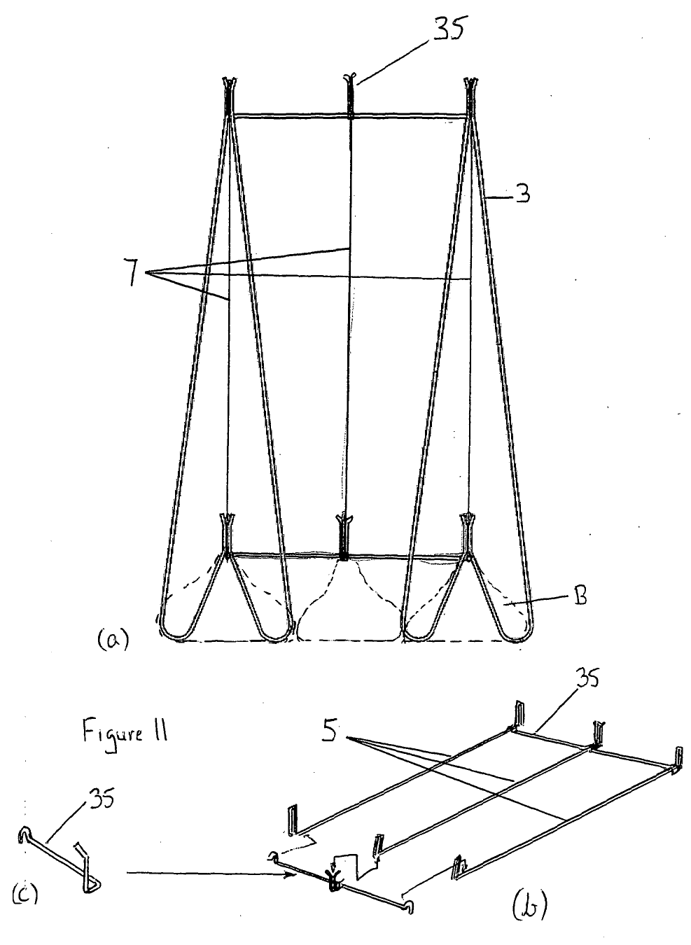

A support frame arrangement comprising two assembled frames secured together by a pair of side bars attached to both the upper and lower cross-members may also be provided. By linking two frames together the assembly is inherently more stable. In FIGS. 11a to 11c, a modification to that arrangement is illustrated in which the side bars include an apex structure to engage the end crook of a cross-member. By providing an additional pair of upper and lower cross-members between the cross-members of the individual support frames, an additional growing bag and its associated plants may be supported. The side bars 35 may be formed so as to present an apex identical to those presented by the uprights so that the crooks of the cross-members engage therewith in a similar manner.

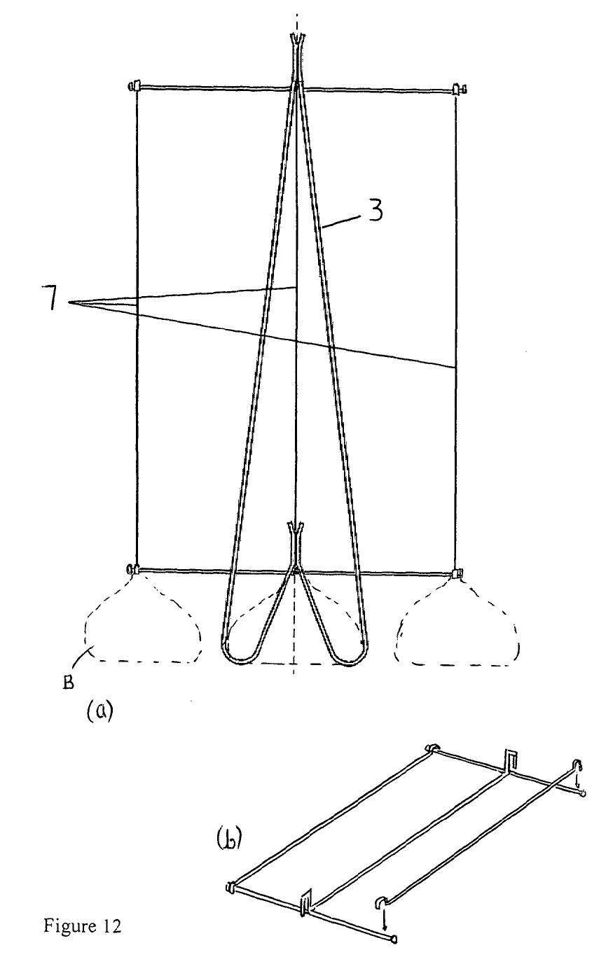

Finally, with reference to FIGS. 12a and 12b, a frame is shown including a modified side bar 37 which may be formed integrally with or clipped to a cross-member so as to facilitate the support of multiple growing bags. Further arrangements of side bar and cross-member are envisages to support further growing bags or to lock one support frame to another

It will of course be understood that the invention is not limited to the specific details described herein, which are given by way of example only, and that various modifications and alterations are possible within the scope of the appended claims.

1.-21. (canceled)

22. A free-standing frame adapted to support a single horticultural growing bag and plants growing therefrom, the frame comprising a pair of substantially A-shaped uprights held in spaced relationship by upper and lower cross-members, wherein the lower cross-member is adapted to engage and support a longitudinal edge of a growing bag resting on its opposite longitudinal edge and to raise it sufficiently to form a substantially ovoid-shaped volume of growing media therein to present an increased depth of media for the roots of plants to grow.

23. A support frame as claimed in claim 22, in which a void is formed over the growing media to retain a volume of water to percolate therethrough.

24. A support frame as claimed in claim 22, in which plant support means is held between the upper and lower cross-members.

25. A support frame as claimed in claim 24, in which the plant support means comprises a plurality of straps tensioned between said cross-members.

26. A support frame as claimed in claim 24, in which the plant support means comprises a mesh.

27. A support frame as claimed in claim 22, in which each A-shaped upright has an upper and a lower apex adapted to engage with one end of a cross-member.

28. A support frame as claimed in claim 22, in which each cross-member is provided with a receiver at each end thereof so sized and shaped as to securely fasten to an apex of an upright.

29. A support frame as claimed in claim 28, in which the cross-member receiver comprises a crook having a biasing force to be overcome when receiving and engaging with an apex of an upright.

30. A support frame as claimed in claim 29, in which the crook is manually push-fitted onto the apex of an upright.

31. A support frame as claimed in claim 22, in which the uprights and cross-members are formed using solid steel wire.

32. A support frame as claimed in claim 22, in which the uprights, cross-members and straps are flat-packed for packaging, distribution, storage and sale.

33. A support frame as claimed in claim 22, in which the frame includes a material skirt adapted to fit over the frame and obscure the growing bag from view.

34. A support frame as claimed in claim 22, in which a cover is provided for the frame to protect plants from frost and/or insect infestations and includes access means for watering and tending to the plants growing in the bag.

35. A support frame as claimed in claim 22, in which the support frame is securable to a second frame to ensure stability by the provision of a side bar connectable between the cross-members.

36. A support frame as claimed in claim 35, in which the side bar includes an apex along its length to which a supplemental cross-member may be secured.

37. A support frame as claimed in claim 22, in which a growing bag is supported between two existing growing bag supporting frames.

38. A support frame as claimed in claim 22, in which a modified side bar is fixed to a cross-member and is adapted to support additional cross-members so that a single frame supports up to three growing bags along their respective longitudinal edges and plants grown therefrom.
